(19) United States
(12) Patent Application Publication
(10) Pub. No.: US 2024/0346239 A1
(43) Pub. Date: Oct. 17, 2024

(54) ALLOWED INPUT DIRECTIVES AND DETERMINING INPUT DATA CRITERIA FOR SPREADSHEETS

(71) Applicant: Georgetown Software House, Inc., Washington, DC (US)

(72) Inventors: Bediako Ntodi George, Washington, DC (US); Mark Enebo Mendell, Long Island City, NY (US)

(21) Appl. No.: 18/630,568

(22) Filed: Apr. 9, 2024

Related U.S. Application Data
(60) Provisional application No. 63/496,609, filed on Apr. 17, 2023.

(51) Int. Cl. G06F 40/18

(52) U.S. Cl. CPC G06F 40/18

(57) ABSTRACT

The present teachings generally include a data processing platform (e.g., a platform hosted by a remote computing resource) that analyzes and compiles information contained in a source spreadsheet, e.g., to determine input data criteria for compatibility with functionality of the spreadsheet. The data processing platform may generate sample input data useful for testing the input data criteria, and create an allowed input directive for the spreadsheet based upon feedback using the input data criteria. The data processing platform may also, or instead, automatically generate an allowed input directive that defines input data criteria, and validate the allowed input directive using automatically generated sample input data. Techniques disclosed may also or instead include iterative testing and debugging processes for improving the reliability of spreadsheets for data processing.

### CROSS-REFERENCE TO RELATED APPLICATIONS

This application claims priority to U.S. Provisional Patent Application No. 63/496,609 filed on Apr. 17, 2023, the entire content of which is hereby incorporated by reference herein.

### FIELD

The present disclosure generally relates to systems and techniques for creating allowed input directives for spreadsheets, e.g., to specify compatibility criteria of input data for use with a spreadsheet.

### BACKGROUND

A spreadsheet is a document including a collection of cells containing data items such as numbers, strings, dates, and so on. Cells may also or instead include instructions e.g., computational instructions such as formulas and functions, and/or snippets of code, pointers and references to other cells, and the like. Cells may also or instead contain other types of information such as data formatting information, presentation information, form widgets, descriptive notes or comments, and so on. Cells in a spreadsheet may be arranged in a geometric fashion, typically in rows and columns having unique identifiers. These rows and columns can also be grouped, where these groups are typically referred to as worksheets. A cell's location in a spreadsheet is usually specified using a combination of the worksheet name and the row/column in which the cell resides.

A drawback to using desktop or web-based spreadsheets as a computational tool is that they generally require hands-on, human-based interaction to manage or verify input data, which can quickly become difficult to undertake when dealing with larger or more complex data sets. While spreadsheets are designed to handle basic mathematical operations and simple data manipulations, they can lack the advanced features and programming capabilities of more specialized data processing tools. Spreadsheets can be prone to errors and data corruption, e.g., due to issues such as incorrect formulas, incorrect values, typographical errors, accidental deletion of or gaps in input data, or the use of inconsistent formatting. The limited error handling ability of simple spreadsheets can make it difficult to design a robust spreadsheet capable of accepting input data from varied sources.

The London Whale scandal involving JPMorgan Chase & Co. in 2012 highlights the potential dangers of relying on spreadsheets for critical calculations. In this instance, a simple spreadsheet was used to track the value of various derivative trades and the associated risk exposure. According to reports, the spreadsheet contained errors that led to a misevaluation of the trades and an underestimation of the associated risks. JPMorgan announced significant losses from the trades, in excess of $6 billion, and the situation eventually led to a significant overhaul of its risk management practices and the departure of several senior executives.

There remains a need for improved systems and techniques to run spreadsheet computations at scale, e.g., in an automated fashion without using excessive computational resources. Moreover, there generally remains a need for improved systems and techniques for validation of input data sets for processing in spreadsheets.

### SUMMARY

The present teachings generally include a data processing platform (e.g., a platform hosted by a remote computing resource) that analyzes and compiles information contained in a source spreadsheet, e.g., to determine input data criteria for compatibility with functionality of the spreadsheet. The data processing platform may generate sample input data useful for testing the input data criteria, and create an allowed input directive for the spreadsheet based upon feedback using the input data criteria. The data processing platform may also, or instead, automatically generate an allowed input directive that defines input data criteria, and validate the allowed input directive using automatically generated sample input data. Techniques disclosed may also or instead include iterative testing and debugging processes for improving the reliability of spreadsheets for data processing.

In an aspect, a computer program product for determining input data criteria for spreadsheets disclosed herein may include computer executable code embodied in a non-transitory computer readable medium that, when executing on one or more computing devices, performs the steps of: receiving a source spreadsheet including a first input data set and a first output data set, where the first input data set is processed according to one or more formulas of the source spreadsheet to generate the first output data set; identifying one or more directives defining functionality of the source spreadsheet including one or more actions taken to generate the first output data set from the first input data set, where at least one of the one or more actions includes application of the one or more formulas; analyzing at least one of the first input data set, the first output data set, and the one or more directives to determine input data criteria including one or more of (i) permissible data types, (ii) permissible data values, (iii) permissible data positions derived from data positions included within at least one of the first input data set and the first output data set of the source spreadsheet, and (iv) one or more input directives describing at least one of a permissible data type, a permissible data value, and a permissible data position of the first input data set; automatically generating a sample input data set in a spreadsheet-compatible format conforming to the input data criteria; processing the sample input data set according to the one or more directives and the one or more formulas of the source spreadsheet to generate a sample output data set; analyzing the sample output data set to identify an error; and, in response to identifying an error, updating the input data criteria based on a relationship between the error and the sample input data set. Other embodiments of this aspect may include corresponding computer systems, apparatus, methods, devices, and computer programs recorded on one or more computer storage devices, each configured to perform one or more of the aforementioned steps.

Implementations may include one or more of the following features. The computer program product may include code that, when executing on one or more computing devices, performs the step of receiving an allowed input directive defining at least one of a permissible data type, a permissible data value, and a permissible data position; and including the allowed input directive in the input data criteria. The allowed input directive may be based on a relationship between the error and the sample input data set. The computer program product may include code that, when executing on one or more computing devices, performs the steps of: using the input data criteria including the allowed input directive, automatically generating a second sample input data set including data in a spreadsheet-compatible format; processing the second sample input data set according to the one or more directives and the one or more formulas of the source spreadsheet to generate a second sample output data set; and analyzing the second sample output data set to identify an error. The computer program product may include code that, when executing on one or more computing devices, performs the steps of: automatically generating an allowed input directive defining at least one of a permissible data type, a permissible data value, and a permissible data position; and including the allowed input directive in the input data criteria. The allowed input directive may describe one or more of the permissible data types and the permissible data values for a collection of cells of the spreadsheet. The allowed input directive may define a requirement that a first collection of cells and a second collection of cells have at least one of: an identical value and/or an identical size. The allowed input directive may describe a relationship between a set of values of the source spreadsheet and one or more collections of cells. The allowed input directive may define that values within a first collection of cells be unique within a worksheet of the source spreadsheet. The computer program product may include code that, when executing on one or more computing devices, performs the step of creating a file executable by a runtime that is configured to process data according to the one or more directives and the one or more formulas of the source spreadsheet. Processing the sample input data set may include reading and executing the file using the runtime as applied to the sample input data set. The file executable by the runtime may be configured to analyze the first input data set for compliance with the input data criteria. The computer program product may include code that, when executing on one or more computing devices, performs the steps of: automatically generating an allowed input directive defining at least one of a permissible data type, a permissible data value, and a permissible data position; and including the allowed input directive in the file. Implementations of the described techniques may include hardware, a method or process, a system, and/or computer software on a computer-accessible medium.

In an aspect, a computer program product for creating allowed input directives for spreadsheets disclosed herein may include computer executable code embodied in a non-transitory computer readable medium that, when executing on one or more computing devices, performs the steps of: receiving a source spreadsheet including first input data processed according to one or more directives of the source spreadsheet to create first output data; analyzing the first input data and the one or more directives to identify input data criteria including at least one of (i) permissible data types, (ii) permissible data values, and (iii) permissible data positions; and testing the input data criteria. Testing the input data criteria may include: (a) generating one or more sample input data sets each including data in a spreadsheet-compatible format conforming to the input data criteria; (b) processing the one or more sample input data sets according to the one or more directives of the source spreadsheet; (c) identifying an error that causes a failure in the processing of the one or more sample input data sets, the error related to at least one of the permissible data types, the permissible data values, and the permissible data positions conforming to the input data criteria; and (d) updating the input data criteria to correct the error by changing at least one of the permissible data types, the permissible data values, and the permissible data positions. The computer program product may include computer executable code embodied in a non-transitory computer readable medium that, when executing on one or more computing devices, performs the steps of: repeating aforementioned steps (a)-(d) until there are no failures in the processing of one or more additional sample input data sets conforming to the updated input data criteria; and creating an allowed input directive for the source spreadsheet that specifies the updated input data criteria. Other embodiments of this aspect may include corresponding computer systems, apparatus, methods, devices, and computer programs recorded on one or more computer storage devices, each configured to perform one or more of the aforementioned steps.

In an aspect, a computer program product for validating an allowed input directive for spreadsheets disclosed herein may include computer executable code embodied in a non-transitory computer readable medium that, when executing on one or more computing devices, performs the steps of: receiving a source spreadsheet including a first input data set and a first output data set, where the first input data set is processed according to one or more formulas of the source spreadsheet to generate the first output data set; identifying one or more directives defining functionality of the source spreadsheet including one or more actions taken to generate the first output data set from the first input data set, where at least one of the one or more actions includes application of the one or more formulas; automatically generating an allowed input directive defining input data criteria including one or more of (i) permissible data types, (ii) permissible data values, (iii) permissible data positions derived from data included within at least one of the first input data set and the first output data set of the source spreadsheet, and (iv) one or more input directives describing at least one of a permissible data type, a permissible data value, and a permissible data position of the first input data set; using the allowed input directive, automatically generating a sample input data set including data in a spreadsheet-compatible format conforming to input data criteria; processing the sample input data set according to the one or more directives and the one or more formulas of the source spreadsheet to generate a sample output data set; analyzing the sample output data set to identify an error; and, in response to identifying an error updating the allowed input directive based on a relationship between the error and the sample input data set. Other embodiments of this aspect may include corresponding computer systems, apparatus, methods, devices, and computer programs recorded on one or more computer storage devices, each configured to perform one or more of the aforementioned steps.

Implementations may include one or more of the following features. The computer program product may include code that, when executing on one or more computing devices, performs the step of creating a file executable by a runtime that is configured to process data according to the one or more directives. Processing the sample input data set may include reading and executing the file using the runtime as applied to the sample input data set. The file executable by the runtime may be configured to analyze the first input data set for compliance with the input data criteria according to the allowed input directive. The runtime may extract the allowed input directive from the file to analyze input data different from the first input data set according to the input data criteria. The computer program product may include code that, when executing on one or more computing devices, performs the steps of: receiving a second input data set different from the first input data set; applying the allowed input directive to the second input data set to determine compliance with the input data criteria; when data within the second input data set is found to deviate from the input data criteria, identifying the second input data set as incompatible for use with the source spreadsheet; and, when data within the second input data set is found to conform to the input data criteria, identifying the second input data set as compatible for use with the source spreadsheet. The allowed input directive may be associated with one or more cells of the source spreadsheet. The allowed input directive may be disposed within one or more of a note and a comment included within the source spreadsheet. Implementations of the described techniques may include hardware, a method or process, a system, and/or computer software on a computer-accessible medium.

In an aspect, a method of determining input data criteria for spreadsheets disclosed herein may include: receiving a source spreadsheet including a first input data set and a first output data set, where the first input data set is processed according to one or more formulas of the source spreadsheet to generate the first output data set; identifying one or more directives defining functionality of the source spreadsheet including one or more actions taken to generate the first output data set from the first input data set, where at least one of the one or more actions includes application of the one or more formulas; analyzing at least one of the first input data set, the first output data set, and the one or more directives to determine input data criteria including one or more of (i) permissible data types, (ii) permissible data values, (iii) permissible data positions derived from data positions included within at least one of the first input data set and the first output data set of the source spreadsheet, and (iv) one or more input directives describing at least one of a permissible data type, a permissible data value, and a permissible data position of the first input data set; automatically generating a sample input data set in a spreadsheet-compatible format conforming to the input data criteria; processing the sample input data set according to the one or more directives and the one or more formulas of the source spreadsheet to generate a sample output data set; analyzing the sample output data set to identify an error; and, in response to identifying an error, updating the input data criteria based on a relationship between the error and the sample input data set.

In an aspect, a system for determining input data criteria for spreadsheets disclosed herein may include a data network, a plurality of processors coupled to the data network, a remote computing resource coupled to the data network, the remote computing resource including a processor and a memory, the memory storing code executable by the processor to perform the steps of: receiving a source spreadsheet including a first input data set and a first output data set, where the first input data set is processed according to one or more formulas of the source spreadsheet to generate the first output data set; identifying one or more directives defining functionality of the source spreadsheet including one or more actions taken to generate the first output data set from the first input data set, where at least one of the one or more actions includes application of the one or more formulas; analyzing at least one of the first input data set, the first output data set, and the one or more directives to determine input data criteria including one or more of (i) permissible data types, (ii) permissible data values, (iii) permissible data positions derived from data positions included within at least one of the first input data set and the first output data set of the source spreadsheet, and (iv) one or more input directives describing at least one of a permissible data type, a permissible data value, and a permissible data position of the first input data set; automatically generating a sample input data set in a spreadsheet-compatible format conforming to the input data criteria; processing the sample input data set according to the one or more directives and the one or more formulas of the source spreadsheet to generate a sample output data set; analyzing the sample output data set to identify an error; and, in response to identifying an error, updating the input data criteria based on a relationship between the error and the sample input data set.

In an aspect, a method of creating allowed input directives for spreadsheets disclosed herein may include: receiving a source spreadsheet including first input data processed according to one or more directives of the source spreadsheet to create first output data; analyzing the first input data and the one or more directives to identify input data criteria including at least one of (i) permissible data types, (ii) permissible data values, and (iii) permissible data positions; and testing the input data criteria. Testing the input data criteria may include: (a) generating one or more sample input data sets each including data in a spreadsheet-compatible format conforming to the input data criteria; (b) processing the one or more sample input data sets according to the one or more directives of the source spreadsheet; (c) identifying an error that causes a failure in the processing of the one or more sample input data sets, the error related to at least one of the permissible data types, the permissible data values, and the permissible data positions conforming to the input data criteria; and (d) updating the input data criteria to correct the error by changing at least one of the permissible data types, the permissible data values, and the permissible data positions. The method also includes repeating steps (a)-(d) until there are no failures in the processing of one or more additional sample input data sets conforming to the updated input data criteria. The method also includes creating an allowed input directive for the source spreadsheet that specifies the updated input data criteria.

In an aspect, a system for creating allowed input directives for spreadsheets disclosed herein may include: a data network, a plurality of processors coupled to the data network, a remote computing resource coupled to the data network, the remote computing resource including a processor and a memory, the memory storing code executable by the processor to perform the steps of: receiving a source spreadsheet including first input data processed according to one or more directives of the source spreadsheet to create first output data; analyzing the first input data and the one or more directives to identify input data criteria including at least one of (i) permissible data types, (ii) permissible data values, and (iii) permissible data positions; and testing the input data criteria by (a) generating one or more sample input data sets each including data in a spreadsheet-compatible format conforming to the input data criteria, (b) processing the one or more sample input data sets according to the one or more directives of the source spreadsheet, (c) identifying an error that causes a failure in the processing of the one or more sample input data sets, the error related to at least one of the permissible data types, the permissible data values, and the permissible data positions conforming to the input data criteria, and (d) updating the input data criteria to correct the error by changing at least one of the permissible data types, the permissible data values, and the permissible data positions. The memory may also configure the processor to repeat steps (a)-(d) until there are no failures in the processing of one or more additional sample input data sets conforming to the updated input data criteria; and to create an allowed input directive for the source spreadsheet that specifies the updated input data criteria.

In an aspect, a method of validating an allowed input directive for spreadsheets disclosed herein may include: receiving a source spreadsheet including a first input data set and a first output data set, where the first input data set is processed according to one or more formulas of the source spreadsheet to generate the first output data set; identifying one or more directives defining functionality of the source spreadsheet including one or more actions taken to generate the first output data set from the first input data set, where at least one of the one or more actions includes application of the one or more formulas; automatically generating an allowed input directive defining input data criteria including one or more of (i) permissible data types, (ii) permissible data values, (iii) permissible data positions derived from data included within at least one of the first input data set and the first output data set of the source spreadsheet, and (iv) one or more input directives describing at least one of a permissible data type, a permissible data value, and a permissible data position of the first input data set; using the allowed input directive, automatically generating a sample input data set including data in a spreadsheet-compatible format conforming to input data criteria; processing the sample input data set according to the one or more directives and the one or more formulas of the source spreadsheet to generate a sample output data set; analyzing the sample output data set to identify an error; and, in response to identifying an error, updating the allowed input directive based on a relationship between the error and the sample input data set.

In an aspect, a system for validating an allowed input directive for spreadsheets disclosed herein may include: a data network, a plurality of processors coupled to the data network, a remote computing resource coupled to the data network, the remote computing resource including a processor and a memory, the memory storing code executable by the processor to perform the steps of: receiving a source spreadsheet including a first input data set and a first output data set, where the first input data set is processed according to one or more formulas of the source spreadsheet to generate the first output data set; identifying one or more directives defining functionality of the source spreadsheet including one or more actions taken to generate the first output data set from the first input data set, where at least one of the one or more actions includes application of the one or more formulas; automatically generating an allowed input directive defining input data criteria including one or more of (i) permissible data types, (ii) permissible data values, (iii) permissible data positions derived from data included within at least one of the first input data set and the first output data set of the source spreadsheet, and (iv) one or more input directives describing at least one of a permissible data type, a permissible data value, and a permissible data position of the first input data set; using the allowed input directive, automatically generating a sample input data set including data in a spreadsheet-compatible format conforming to input data criteria; processing the sample input data set according to the one or more directives and the one or more formulas of the source spreadsheet to generate a sample output data set; analyzing the sample output data set to identify an error; and, in response to identifying an error updating the allowed input directive based on a relationship between the error and the sample input data set.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 illustrates a system for creating allowed input directives for spreadsheets, in accordance with a representative embodiment.

FIG. 2 is a flow chart of a method for creating allowed input directives for spreadsheets, in accordance with a representative embodiment.

FIG. 3 is a flow chart of a method for creating allowed input directives for spreadsheets, in accordance with a representative embodiment.

FIG. 4 is a flow chart of a method for creating allowed input directives for spreadsheets, in accordance with a representative embodiment.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “of” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, computer program products, and methods disclosed herein relate to systems and techniques to run spreadsheet computations at scale. Further, the present teachings include systems and techniques for processing input data sets in spreadsheets. That is, an aspect of the present teachings includes a data processing platform with components (e.g., hardware and/or software components) configured to analyze a source spreadsheet in order to ascertain the type of input data included therein, identify how the source spreadsheet manipulates that input data or otherwise generates output data therefrom, and determine criteria for input data to be compatible for processing by the spreadsheet. Moreover, the data processing platform may create a file related to the source spreadsheet that includes transformed input data and/or directives that define functionality of the source spreadsheet and/or define criteria for allowed inputs. This file may be encrypted or otherwise protected such that only a user (or a set of users, e.g., an enterprise) having proper authorization can access and/or use this file. The data processing platform may create or otherwise utilize one or more runtimes that, when executed in conjunction with the file, can mimic functionality of the source spreadsheet and/or other useful functionality applied to the input data or other data that is different from the input data.

The present teachings may be similar to concepts discussed and contemplated in the applicant's own U.S. Pat. No. 11,562,131 and/or U.S. Pat. App. Pub. No. US2023/0244864, where the entire contents of each of the foregoing is hereby incorporated by reference herein. Similar to one or more of the aforementioned patent properties, the present teachings may involve techniques for deferring (temporally and spatially) the generation, manipulation, and arrangement of cells in an electronic spreadsheet.

It will thus be understood that the present teachings may include creating (e.g., automatically generating) an allowed input directive for a spreadsheet, where the directive may describe compatibility criteria to be met by input data. Examples of such input data criteria include data types, data values, data positions, and so on. The allowed input directive may be associated, attached, and/or embedded within the spreadsheet for subsequent use thereof, e.g., for validation of input data prior to processing.

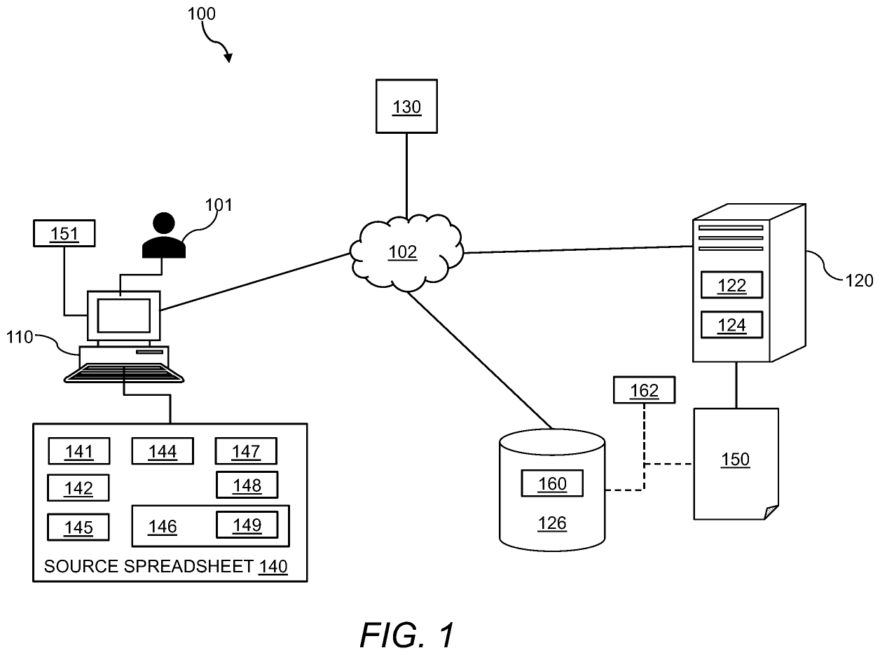

FIG. 1 illustrates a system for creating allowed input directives for spreadsheets, in accordance with a representative embodiment. In some aspects, the system 100 may also or instead be utilized to validate an allowed input directive for spreadsheets. In general, the system 100 may include a networked environment where a data network 102 interconnects a plurality of participating devices and/or users in a communicating relationship. The participating devices may, for example, include any number of user devices 110, remote computing resources 120, and other resources 130.

The data network 102 may be any network(s) or internetwork(s) suitable for communicating data and information among participants in the system 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMAX-Advanced (IEEE 802.16m)), fifth generation (e.g., 5G), and/or other technologies, as well as any of a variety of corporate area or local area networks and other switches, routers, hubs, gateways, and the like that might be used to carry data among participants in the system 100.

Each of the participants of the data network 102 may include a suitable network interface comprising, e.g., a network interface card, which term is used broadly herein to include any hardware (along with software, firmware, or the like to control operation of same) suitable for establishing and maintaining wired and/or wireless communications. The network interface card may include without limitation a wired Ethernet network interface card (“NIC”), a wireless 802.11 networking card, a wireless 802.11 USB device, or other hardware for wired or wireless local area networking. The network interface may also or instead include cellular network hardware, wide area wireless network hardware or any other hardware for centralized, ad hoc, peer-to-peer, or other radio communications that might be used to connect to a network and carry data. In another aspect, the network interface may include a serial or USB port to directly connect to a local computing device such as a desktop computer that, in turn, provides more general network connectivity to the data network 102.

The user devices 110 may include any devices within the system 100 operated by one or more users 101 for practicing the techniques as contemplated herein. Specifically, the user devices 110 may include any device for creating, preparing, editing, processing, receiving, and/or transmitting (e.g., over the data network 102) a source spreadsheet 140 and information related thereto such as a first input data set 141, a first output data set 142, one or more formulas 144, one or more directives 146, and one or more worksheets 145. Similarly, the user devices 110 may include any device for creating, preparing, editing, processing, receiving, and/or transmitting (e.g., over the data network 102) other data or files in the system 100, such as a file 150 and second input data 151 as described herein. The user devices 110 may also or instead include any device for managing, monitoring, or otherwise interacting with tools, platforms, and devices included in the systems and techniques contemplated herein. The user devices 110 may be coupled to the data network 102, e.g., for interaction with one or more other participants in the system 100.

By way of example, the user devices 110 may include one or more desktop computers, laptop computers, network computers, tablets, mobile devices, portable digital assistants, messaging devices, cellular phones, smart phones, portable media or entertainment devices, or any other computing devices that can participate in the system 100 as contemplated herein. As discussed above, the user devices 110 may include any form of mobile device, such as any wireless, battery-powered device, that might be used to interact with the networked system 100. It will also be appreciated that one of the user devices 110 may coordinate related functions (e.g., identifying one or more directives 146, analyzing input data-such as the first input data set 141, and so on) as they are performed by another entity such as one of the remote computing resources 120 or other resources 130.

Each user device 110 may generally provide a user interface, such as any of the user interfaces described herein. The user interface may be maintained by a locally executing application on one of the user devices 110 that receives data from, e.g., the remote computing resources 120 or other resources 130. In other embodiments, the user interface may be remotely served and presented on one of the user devices 110, such as where a remote computing resource 120 or other resource 130 includes a web server that provides information through one or more web pages or the like that can be displayed within a web browser or similar client executing on one of the user devices 110. The user interface may in general create a suitable visual presentation for user interaction on a display device of one of the user devices 110, and provide for receiving any suitable form of user input including, e.g., input from a keyboard, mouse, touchpad, touch screen, hand gesture, or other use input device(s).

The remote computing resources 120 may include, or otherwise be in communication with, a processor 122 and a memory 124, where the memory 124 stores code executable by the processor 122 to perform various techniques of the present teachings. More specifically, a remote computing resource 120 may be coupled to the data network 102 and accessible to the user device 110 through the data network 102, where the remote computing resource 120 includes a processor 122 and a memory 124, where the memory 124 stores code executable by the processor 122 to perform the steps of a method according to the present teachings.

The remote computing resources 120 may also or instead include data storage, a network interface, and/or other processing circuitry. In the following description, where the functions or configuration of a remote computing resource 120 are described, this is intended to include corresponding functions or configuration (e.g., by programming) of a processor 122 of the remote computing resource 120, or in communication with the remote computing resource 120. In general, the remote computing resources 120 (or processors 122 thereof or in communication therewith) may perform a variety of processing tasks related to the creating of allowed input directives for spreadsheets as discussed herein. For example, the remote computing resources 120 may manage information received from one or more of the user devices 110, and provide related supporting functions such as identifying, revising, and/or generating one or more directives 146, analyzing, generating, and/or processing one or more data sets (e.g., the first input data set 141 or a sample input data set 147, to generate a sample output data set 148), communicating with other resources 130, storing data, and the like. The remote computing resources 120 may also or instead include backend algorithms that react to actions performed by a user 101 at one or more of the user devices 110. The backend algorithms may also or instead be located elsewhere in the system 100.

The remote computing resources 120 may also or instead include a web server or similar front end that facilitates web-based access by the user devices 110 to the capabilities of the remote computing resource 120 or other components of the system 100. A remote computing resource 120 may also or instead communicate with other resources 130 in order to obtain information for providing to a user 101 through a user interface on the user device 110. Where the user 101 specifies certain criteria for data processing, this information may be used by a remote computing resource 120 (and any associated algorithms) to access other resources 130. Additional processing may be usefully performed in this context such as recommending certain data processing operations and techniques.

A remote computing resource 120 may also or instead maintain, or otherwise be in communication with, a database 126 of content such as one or more runtimes 160, along with an interface for users 101 at the user devices 110 to utilize the content of such a database 126. Thus, in one aspect, a remote computing resource 120 may include a database 126 of runtimes 160, and the remote computing resource 120 may act as a server that provides a platform for selecting and using a runtime 160, and/or providing supporting services related thereto.

A remote computing resource 120 may also or instead be configured to manage access to certain content (e.g., for an enterprise associated with a user 101 of the user device 110). In one aspect, a remote computing resource 120 may manage access to a component of the system 100 by a user device 110 according to input from a user 101.

The other resources 130 may include any resources that may be usefully employed in the devices, systems, and methods as described herein. For example, the other resources 130 may include without limitation other data networks, human actors (e.g., programmers, researchers, annotators, editors, analysts, and so forth), sensors (e.g., audio or visual sensors), data mining tools, computational tools, data monitoring tools, and so forth. The other resources 130 may also or instead include any other software or hardware resources that may be usefully employed in the networked applications as contemplated herein. For example, the other resources 130 may include payment processing servers or platforms used to authorize payment for access, content or feature purchases (e.g., certain sample input data sets 147, files 150, and/or runtimes 160), or otherwise. In another aspect, the other resources 130 may include certificate servers or other security resources for third-party verification of identity, encryption or decryption of data, and so forth. In another aspect, the other resources 130 may include a desktop computer or the like co-located (e.g., on the same local area network with, or directly coupled to through a serial or USB cable) with one of the user devices 110 or remote computing resources 120. In this case, the other resource 130 may provide supplemental functions for the user device 110 and/or remote computing resource 120. Other resources 130 may also or instead include supplemental resources such as scanners, cameras, printers, input devices, and so forth.

The other resources 130 may also or instead include one or more web servers that provide web-based access to and from any of the other participants in the system 100. While depicted as a separate network entity, it will be readily appreciated that the other resources 130 (e.g., a web server) may also or instead be logically and/or physically associated with one of the other devices described herein, and may, for example, include or provide a user interface for web access to a remote computing resource 120 or a database 126 in a manner that permits user interaction through the data network 102, e.g., from a user device 110.

It will be understood that the participants in the system 100 may include any hardware or software to perform various functions as described herein. For example, one or more of the user device 110 and the other resources 130 may include a memory 124 and a processor 122.

The various components of the networked system 100 described above may be arranged and configured to support the techniques described herein in a variety of ways. For example, in one aspect, a user device 110 connects through the data network 102 to a server (e.g., that is part of one or more of the remote computing resource 120 or other resources 130) that performs a variety of processing tasks related to creating allowed input directives for spreadsheets. For example, the remote computing resource 120 may include a server that hosts a website that runs a platform for analyzing and/or testing spreadsheets and creating allowed input directives therefor. More specifically, a user 101 associated with the user device 110 and having appropriate permissions for using the system 100 may use the user device 110 to transmit a source spreadsheet 140 over the data network 102 to the server. The source spreadsheet 140 may include input data (e.g., a first input data set 141), one or more formulas 144 configured to manipulate the input data thereby generating output data (e.g., a first output data set 142), and one or more directives 146 associated with the source spreadsheet 140 (such as an input directive). The one or more directives 146 may describe at least one of the first input data set 141, the one or more formulas 144, and the first output data set 142. A directive 146 describing criteria for an input data set may be referred to as an input directive. Other directives that may not directly describe criteria for input data, but that may indirectly describe criteria for input data (e.g., directives associated with output data or with intermediate data) may also be referred to as input directives. The directives 146 may include one or more actions 149, such as actions taken to generate the first output data set 142 from the first input data set 141. The remote computing resource 120 may receive the source spreadsheet 140 from the user 101 over the data network 102 for analysis and processing thereof. The present teachings may further include creating a file 150 executable by a runtime 160, e.g., a runtime 160 associated with the user 101 or an enterprise with which the user 101 is associated. The file 150 executable by a runtime 160 may be configured to process data in accordance with one or more directives 146 (e.g., of the source spreadsheet 140). For example, the second input data 151 may be transmitted via the data network 102 for processing as an input to the file 150. The reading and execution of the file 150 by the runtime 160 may occur anywhere in the system 100, such as locally at the user device 110, or remotely at the remote computing resource 120 or a web platform hosted by same. For example, the remote computing resource 120 may transmit one or more of the file 150 and the runtime 160 to the user device 110 over the data network 102, where a user 101 operating the user device 110 may then read and execute the file 150 using the runtime 160. Also or instead, the remote computing resource 120 may read and execute the file 150 using the runtime 160, and then the remote computing resource 120 may transmit output 162 from the runtime 160 to the user device 110 over the data network 102.

In an aspect, many of the techniques of the present teachings are performed by the remote computing resource 120. For example, the remote computing resource 120 may include an analysis engine (or otherwise a processor 122) configured by computer-executable code to analyze and read the source spreadsheet 140, e.g., to determine what worksheets 145 are in the source spreadsheet 140, what formulas 144 are in these worksheets 145, what directives 146 may be associated with the source spreadsheet 140, what input data criteria may be applicable to the first input data set 141, and so on. Such an analysis engine of the remote computing resource 120 may extract some or all directives 146 of the source spreadsheet 140. In addition, or instead, the analysis engine may automatically generate allowed input directives or sample input data, e.g., for use in validating input data criteria for spreadsheets. The output of an analysis engine of the remote computing resource 120 may thus include a file 150 that can be read and executed by a runtime 160 that was created for, or is otherwise associated with, the same account of the user 101. In this manner, only certain runtimes 160 may be able to read and execute certain files 150. In other aspects, certain runtimes 160 may be generic, meaning that a single runtime 160 may be able to be used to read and execute different files 150 associated with different users 101.

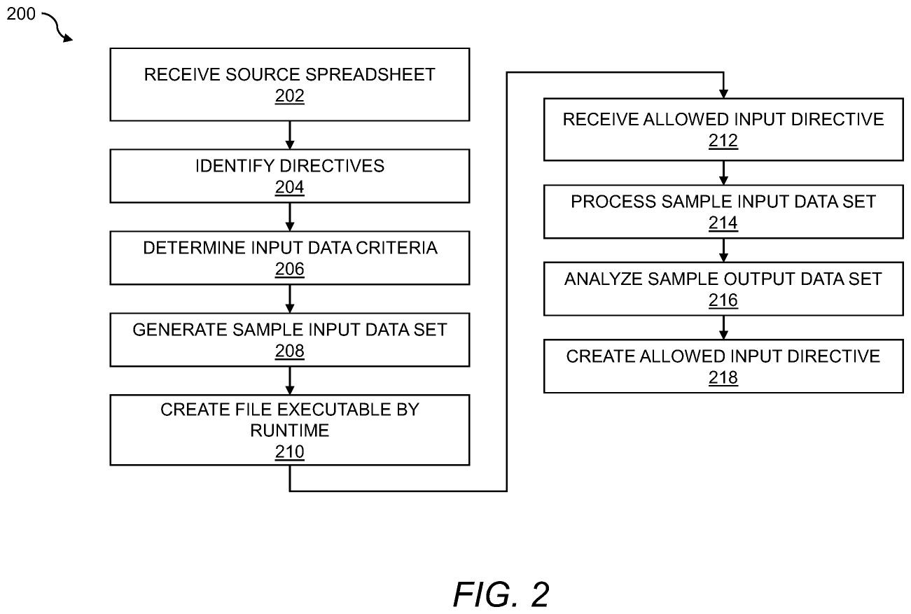

FIG. 2 is a flow chart of a method for creating allowed input directives for spreadsheets, in accordance with a representative embodiment. The method 200 may utilize any of the systems or platforms described herein, e.g., the system 100 described with reference to FIG. 1. In general, the method 200 represents a technique for determining input data criteria for a spreadsheet, generating sample input data useful for testing the input data criteria, and creating an allowed input directive based upon the input data criteria.

As shown in step 202, the method 200 may include receiving a source spreadsheet, such as the source spreadsheet 140 of the system 100 described above. A platform (e.g., the remote computing resource 120 of FIG. 1) may receive the source spreadsheet (e.g., from a user 101) for processing. This step 202 may also or instead include creating the source spreadsheet. For example, the source spreadsheet may be created by, or otherwise associated with, a user or client of the platform. The source spreadsheet may be transmitted by the user or client for processing, and may be received by the platform. For example, an accounting firm or the like may be a client of a platform utilizing a system for processing data according to functionality of a spreadsheet, and a user of the accounting firm (e.g., a business analyst or the like) may have created or otherwise retrieved the source spreadsheet for transmission to the platform for processing of the source spreadsheet. In this manner, the method 200 may further include a user taking steps to gain access to the platform—e.g., for transmission of the source spreadsheet thereto—by, for example, logging onto the platform via a locally or remotely hosted user interface.

As described herein, the source spreadsheet may include a first input data set and one or more formulas configured to manipulate the first input data set, thereby generating a first output data set. For example, the source spreadsheet may include data related to amortizing a loan, and more specifically the source spreadsheet may create an amortization schedule for a fixed rate term loan. In this example, input data may include one or more of an original balance, an interest rate, and a term; output data may include a principal balance, interest due, and/or a full amortization schedule; and the one or more formulas may include what is needed to process the input data to generate the output data.

As shown in step 204, the method 200 may include identifying one or more directives defining functionality of the source spreadsheet (e.g., one or more directives 146 defining functionality of the source spreadsheet 140 of FIG. 1). As used herein, a directive may generally be a component within a spreadsheet (or otherwise associated with a spreadsheet or content included therein) that describes a feature of the spreadsheet or content included therein or for use therewith (e.g., a directive may describe criteria to be applied to input data). For example, a directive may describe at least one of the first input data set, one or more formulas, and the first output data set. In general, a directive may define functionality of the source spreadsheet—e.g., what the spreadsheet is doing to input data, such as how that input data is being manipulated, organized, compiled, displayed, or the like. A directive may be included within or otherwise associated with the source spreadsheet—e.g., embedded in a comment and/or in some other manner associated with a spreadsheet, worksheet, column, and/or cell.

As discussed herein, a directive may be embedded within the source spreadsheet. For example, a directive may be disposed within one or more of a note and a comment included within the source spreadsheet. In this manner, the directive may be added by a user of a platform or system as described herein for securely processing disparate data sets according to functionality of a spreadsheet—e.g., an end user associated with an enterprise that is a client of such a platform, or an administrator of such a platform. Thus, a directive may be manually added by a user. Also, or instead, the directive may be added automatically, e.g., by software that analyzes the functionality of the source spreadsheet and then adds one or more directives accordingly, based on the analysis. By way of example, one or more directives may be automatically generated as one or more of data and formulas that are entered into the source spreadsheet.

The present teachings may be capable of utilizing user-added directives—e.g., associating, attaching, and/or embedding directives that call for cell generation, manipulation, and/or arrangement in the comment or note creation facility available in most spreadsheets—and this may provide the advantage of familiarity for users, as many spreadsheet application users are familiar with the art of associating, attaching, and/or embedding a comment in a cell.

A directive may also or instead be attached or otherwise appended to the source spreadsheet. For example, a source spreadsheet may be associated with a separate file or worksheet that includes one or more directives therein.

One familiar with the art will appreciate that other methods for associating directives to cells or worksheets also exist. One embodiment of associating these types of cell generation, manipulation, and/or arrangement directives may be to create a worksheet in the spreadsheet and use the worksheet to contain directives. Another embodiment may incorporate these directives in a separate file associated with the spreadsheet. Another embodiment may store this information in a datastore or database. Yet another embodiment may provide a specialized widget or menu item that allows a user to associate to a cell its generation, manipulation, and/or arrangement directives. The use of the common spreadsheet construct called a “named reference” is another example of an embodiment that may also or instead be used to hold cell generation, manipulation, and/or arrangement directives. Still another embodiment may include a mechanism or apparatus for submitting cell generation, manipulation, and/or arrangement instructions sometime after the spreadsheet was created, e.g., via a web browser. Another embodiment may store the directive directly in the cell as a value.

A directive may define one or more actions (e.g., the action 149 described with reference to FIG. 1) to be taken to generate the first output data set from the first input data set. For example, at least one of the one or more actions may include application of the one or more formulas within the source spreadsheet to the first input data. Some further examples of actions defined by directives include, but are not limited to, one or more of: create cells; copy cells; stop creating cells; filter cells; sort cells after generation; flip cell order; label cells; remove cells; store cells; discard cells; and/or the like.

As shown in step 206, the method 200 may include analyzing at least one of the first input data set, the first output data set, and the one or more directives to determine input data criteria. Input data criteria may include any criteria to be satisfied so that the input data may be correctly processed as intended by the source spreadsheet (e.g., without resulting in an error). Examples of input data criteria include: (i) a permissible data type-such as a numerical type, a string or text type, a logical type, etc.; (ii) a permissible data value—for example, an integer value, a numeric value within a specified numeric range, a categorical value within a specified category (e.g., the value ‘Wednesday’ may be a permissible data value in a category of ‘days of the week’), and so on; and (iii) a permissible data position, such as a row, column, cell, or group of cells. Input data criteria may be derived from at least one of the first input data set and the first output data set of the source spreadsheet. For example, an input data criteria may require that the first column of an input data set have data values in the category ‘days of the week.’ This input data criteria may have been determined by an analysis of first input data set determining that the first input data set met such a criteria.

Input data criteria may also, or instead, include one or more input directives that describe at least one of a permissible data type, a permissible data value, and a permissible data position of the first input data set. For example, a directive may set forth that the input data includes permissible data values such as dates, times, currency, numbers, accounting data, percentages, monetary values (e.g., costs, expenses, etc.), ranges of any of the foregoing, and the like. In some instances, one or more input directives may be received with the source spreadsheet (e.g., as described in step 202).

In addition, or instead, the input data criteria may be used to create one or more allowed input directives. An allowed input directive may be attached to, or otherwise associated with, the source spreadsheet as described herein for directives in general. In this manner, an allowed input directive may be saved and/or packaged with the source spreadsheet, and may be used to validate input data provided for future processing by the source spreadsheet. The allowed input directive may define at least one of a permissible data type, a permissible data value, and a permissible data position. In an example case, the allowed input directive may be based on a relationship between the sample input data set and an error (e.g., an error resulting from an attempt to process the sample input data set according to functionality of the spreadsheet). For example, a sample input data set may include one or more values of zero and the spreadsheet may attempt to execute a function including division by those values, resulting in an error. As a result, an allowed input directive may require that certain values of input be non-zero numeric values. An allowed input directive may be included in the input data criteria. For example, input data criteria may be updated to include one or more received or determined allowed input directives as part of an iterative testing and de-bugging process applied to the source spreadsheet.

As shown in step 208, the method 200 may include generating (e.g., automatically generating) a sample input data set. The sample input data set (e.g., the sample input data set 147 as described above) may be automatically generated by a computing resource (such as the remote computing resource 120 of the system 100). The sample input data set may be in a spreadsheet-compatible format, to facilitate processing of the sample input data by the source spreadsheet. Examples of spreadsheet-compatible formats include spreadsheet files (e.g., Microsoft Excel (*.xlsx), OpenDocument Spreadsheet (*.ods), etc.), comma-separated values (*.csv) format, a list of lists, a dataframe, and others.

The generated sample input data set may conform to the input data criteria—e.g., the input data criteria determined in step 206. In some cases, certain properties of the first input data set may be detected by the system and/or used to determine input data criteria. In some cases, such as if no related input directives are detected, the generated sample input data set may include input data that diverges from the properties of the first input data set. For example, a first input data set may include a column containing positive integers. In the absence of an input directive requiring positive integers, the generated sample input data set may include divergent data, such as negative integers, zero values, decimal numbers, string values, etc. In another example, a first input data set may include a column containing whole numbers. In the absence of an input directive requiring whole numbers, the generated sample input data set may include divergent data, such as decimals and fractions. A sample input data set generated in this manner may be used to test how the spreadsheet handles many different types of input data that may be submitted intentionally or erroneously.

As shown in step 210, the method 200 may include creating a file executable by a runtime. The file may be configured to process data (e.g., input data) according to the one or more directives and the one or more formulas of the source spreadsheet. The file executable by the runtime may be configured to analyze an input data set for compliance with the input data criteria (e.g., the input data criteria determined in step 206). The file may be, for example, a spreadsheet containing one or more directives (e.g., an allowed input directive) for creating a custom, encrypted file that can be used with an associated runtime for generating, manipulating, and/or arranging data in the same or a similar manner as the original spreadsheet, but without using the original spreadsheet. Such a file may therefore include instructions necessary to process an input data set different from the sample input data set, as well as input data criteria suitable for verifying that the input data set is compatible with the requirements for processing. A file of this type may therefore be significantly more robust (e.g., less prone to output errors or failure to process input data) than a typical spreadsheet.

As shown in step 212, the method 200 may include receiving an allowed input directive. An allowed input directive may be attached to or otherwise associated with the source spreadsheet as described herein. An allowed input directive may also, or instead, be transmitted by a user of the system (e.g., in the system 100 of FIG. 1, a user 101 may transmit an allowed input directive as a directive 146 either with transmission of a source spreadsheet 140 or as an independent transmission).

As used herein, receiving an allowed input directive may include accessing an allowed input directive that has been automatically generated by a computing resource of the system. Thus, in this manner, the present teachings may also or instead include the generation of an allowed input directive, e.g., for inclusion in input data criteria and/or for updating input data criteria. For instance, in an example discussed above, when the division by a value of zero results in an error, the system may automatically generate an allowed input directive requiring certain values of the input data to be non-zero numeric values. The input data criteria may then be updated to include the automatically generated allowed input directive. This update may be followed by additional testing with sample input data—for example, a second sample input data set may be automatically generated in a spreadsheet-compatible format, processed according to the one or more directives and the one or more formulas of the source spreadsheet to generate a second sample output data set, and the second sample output data set may be analyzed to identify any additional errors.

As shown in step 214, the method 200 may include processing the sample input data set (e.g., the sample input data set 147 of FIG. 1). The sample input data set may be processed according to the one or more directives (including any allowed input directives) and the one or more formulas of the source spreadsheet to generate a sample output data set. Processing may be performed by a computing resource of a system, e.g., the remote computing resource 120 of the system 100 described above. Processing the sample input data set may include reading and executing a file using a runtime, e.g. as described in step 210.

As shown in step 216, the method 200 may include analyzing the sample output data set (e.g., the sample output data set 148 of FIG. 1). The sample output data set may be analyzed by a computing resource of a system (e.g., system 100). In addition, or instead, a sample output data set may be analyzed by a user of a system (e.g., a manual review). Analysis of the sample output data set may include error handling or checking and/or output data verification against an expected result (e.g., an expected result may be defined in a directive associated with the source spreadsheet).

As shown in step 218, the method 200 may include creating an allowed input directive (e.g., a directive 146 as described in discussion of FIG. 1). The allowed input directive may be created, e.g., automatically generated, by a computing resource of a system (e.g., system 100). In general, the allowed input directive may define at least one of a permissible data type, a permissible data value, and a permissible data position. In some cases, the allowed input directive may be created in response to identifying an error (such as an error identified in relation to the sample output data set). Such an allowed input directive may be based on a relationship between the error and the sample input data set. Referring again to an earlier example, if a function including a division operation results in an error and the sample input data set includes values of zero, an allowed input directive may be created requiring that certain portions of the input data be non-zero. This step 218 may also include updating the input data criteria to include the created allowed input directive, which may be useful for an iterative testing process.

Step 218 may also or instead include, in response to identifying an error, updating the input data criteria based on a relationship between the error and the sample input data set. In some aspects, this step may include generating an allowed input directive based on the relationship between the error and the sample input data set, and updating the previously-determined input data criteria to include, or to otherwise account for, a newly-generated allowed input directive. This may also or instead include updating a previously received or otherwise identified allowed input directive that is included within the input data criteria.

Thus, it will be understood that, in the present teachings, input data criteria may be identified, determined, and/or created through an analysis of input data sets, output data sets, and/or directives of a spreadsheet, where such directives may include an allowed input directive. And, using techniques of the present teachings disclosed herein, the input data criteria can be updated and/or fine-tuned, e.g., through the inclusion of a newly-created or updated allowed input directive, or through inclusion of an allowed input directive that is otherwise received in a platform according to the present teachings. Thus, it will be understood that input data criteria may include one or more allowed input directives, which generally can be created or updated using the techniques described herein.

By way of example, the allowed input directive may describe one or more of the permissible data types and the permissible data values for a collection of cells of the spreadsheet. Examples of permissible data types include, but are not limited to, an integer, a decimal, a percentage, a date, a time, a monetary value, a text string, a logical value, and the like. Permissible data values may include, for example, an integer range (e.g., 1-10 or (−1)-(−100)), a date range (e.g., Jan. 1, 2020-Dec. 31, 2020), specific logical values (e.g., true/false or 0/1), and so on. Permissible data values for text may include members of a set of text values, such as a state of the United States, a day of the week, a month of the year, etc. This type of allowed input directive may be referred to as an “allowed value directive.” An allowed value directive may also, or instead, specify cardinality for at least a portion of the input (e.g., the number of elements in the input, the frequency with which a specific value appears in the input, or the variation—or lack thereof-within a set of values in the input).

An allowed input directive may define a relationship between a first collection of cells (e.g., a row or a column) and a second collection of cells. In one example, the allowed input directive may define a requirement that a first collection of cells and a second collection of cells have identical values (e.g., as may be required for double-entry bookkeeping). This type of allowed input directive may be referred to as an “identical column directive” or an “identical row directive.” In another example, the allowed input directive may define a requirement that a first collection of cells and a second collection of cells have an identical size. For instance, the first collection of cells and the second collection of cells may be required to have the same number of rows. This type of directive may be referred to as an “identical row count directive.”

An allowed input directive may describe a relationship between a set of values of the source spreadsheet and one or more collections of cells. For example, a cell including an email address may be marked as an identifier for other data in the same row (e.g., the email address may be associated with a user name, a phone number, an account number, and/or the like in the same row as the cell with the email address). An allowed input directive may indicate that each cell in a column of cells containing email addresses be associated with other specific cells, e.g., with other cells in the same row. In this example, the allowed input directive may be referred to as an “identifier directive”.

An allowed input directive may define that certain input values (e.g., values within a first collection of cells) be unique within a worksheet of the source spreadsheet. In an example case, a first collection of cells may be a column of user names for users of a system. To avoid duplicate entries of users, or duplicate use of user names, the allowed input directive may require values within the first collection of cells to be unique within a worksheet containing input data. This type of allowed input directive may be referred to as a “unique directive”.

The method 200 described above may be performed in whole or in part by a computer program product, e.g., in conjunction with a remote computing resource. Thus, an aspect described herein includes a computer program product for creating allowed input directives for spreadsheets, or otherwise updating input data criteria, the computer program product comprising computer executable code embodied in a non-transitory computer readable medium that, when executing on one or more computing devices, performs the steps of: receiving a source spreadsheet including a first input data set and a first output data set, where the first input data set is processed according to one or more formulas of the source spreadsheet to generate the first output data set; identifying one or more directives defining functionality of the source spreadsheet including one or more actions taken to generate the first output data set from the first input data set, where at least one of the one or more actions includes application of the one or more formulas; analyzing at least one of the first input data set, the first output data set, and the one or more directives to determine input data criteria including one or more of (i) permissible data types, (ii) permissible data values, (iii) permissible data positions derived from data positions included within at least one of the first input data set and the first output data set of the source spreadsheet, and (iv) one or more input directives describing at least one of a permissible data type, a permissible data value, and a permissible data position of the first input data set; automatically generating a sample input data set in a spreadsheet-compatible format conforming to the input data criteria; processing the sample input data set according to the one or more directives and the one or more formulas of the source spreadsheet to generate a sample output data set; analyzing the sample output data set to identify an error; and in response to identifying an error, updating the input data criteria based on a relationship between the error and the sample input data set. The method 200 described above may also or instead be performed by a system, such as the system 100 of FIG. 1.

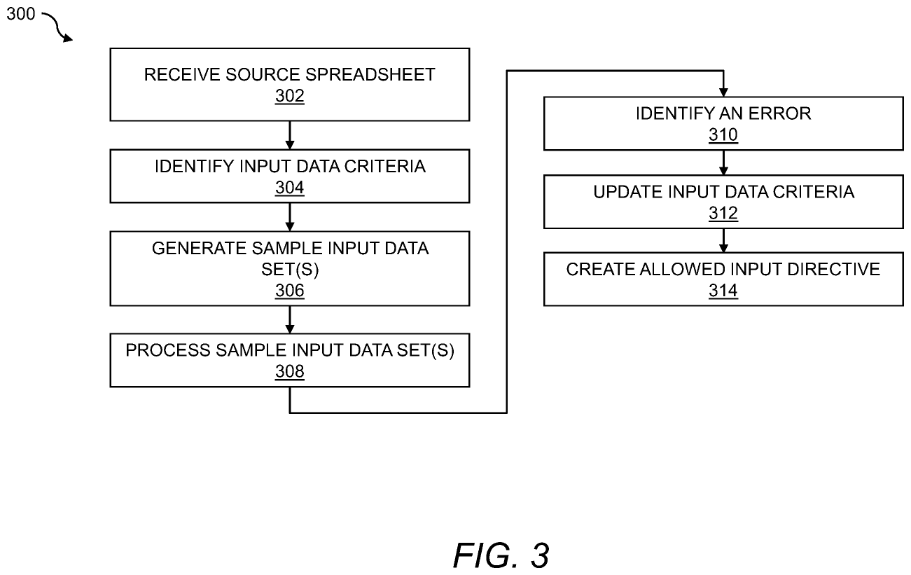

FIG. 3 is a flow chart of a method for creating allowed input directives for spreadsheets, in accordance with a representative embodiment. The method 300 may utilize any of the systems or platforms described herein, e.g., the system 100 described with reference to FIG. 1. In general, the method 300 represents a technique for iteratively generating and testing input data criteria until no processing failures are detected, and/or creating one or more allowed input directives including the input data criteria.

As shown in step 302, the method 300 may include receiving a source spreadsheet, such as the source spreadsheet 140 of the system 100 of FIG. 1. Step 302 may be similar to step 202 of the method 200 of FIG. 2, and may thus include any of the features described with reference thereto. The source spreadsheet may include first input data (e.g., a first input data set 141 of the system 100) processed according to one or more directives of the source spreadsheet (e.g., one or more directives 146 of the system 100) to create first output data (e.g., a first output data set 142 of the system 100).

As shown in step 304, the method 300 may include identifying input data criteria. The input data criteria may be identified by analyzing one of the first input data and the one or more directives. The input data criteria may include at least one of (i) permissible data types, (ii) permissible data values, and (iii) permissible data positions, e.g. as described in the discussion of step 206 of the method 200, and elsewhere herein.

As shown in step 306, the method 300 may include generating one or more sample input data sets. The one or more sample input data sets may be automatically generated by a computing resource (e.g., the remote computing resource 120 of the system 100), for example, as described in the discussion of step 208 of the method 200. In general, the sample input data sets may conform to the input data criteria and may differ from the first input data set in a variety of ways. Referring again to the example where a first input data set may include positive integers, the sample input data sets may include input data having (alone or in combination): negative integers, decimal numbers, zero values, numeric values outside the range provided in the first input data set, numeric values formatted differently from the first input data set, non-numeric values (e.g., text or logical values), empty cells, and so on. In one case, a single sample input data set may include various types of input data. In another case, multiple sample input data sets may each include input data that is varied in a particular type of way; this type of input date may be useful in identifying the cause of specific errors. In general, it is desirable for the sample input data set(s) to provide many different types of allowed input data in order to provide a rigorous test of the spreadsheet.

As shown in step 308, the method 300 may include processing the sample input data set(s). The sample input data set(s) may be processed according to the one or more directives (including any existing allowed input directives) and the one or more formulas of the source spreadsheet to generate one or more sample output data sets. Processing may be performed by a computing resource of a system, e.g., the remote computing resource 120 of the system 100 described above.

As shown in step 310, the method 300 may include identifying an error. In some cases, an error may be identified in one or more output data sets. An error may describe any situation that causes a failure in the processing of the one or more sample input data sets. Examples of an error include generating an output data set that explicitly includes an error or warning, or the complete failure to process the input data set-in which case an output data set may or may not be generated. The error may relate to at least one of the permissible data types, the permissible data values, and the permissible data positions conforming to the input data criteria; in such a case, modification of the input data criteria may be recommended to reduce or eliminate future errors. Another type of error may involve non-compliance with additional directives of the spreadsheet. For example, a directive may specify an expected range and/or expected formatting for an output. In such a case, the sample input data may be processed, and may provide a seemingly valid sample output, yet the sample output may be outside of the expectations specified by a directive.

In some cases, an error may not be identified in the output data set(s). When no error is identified, further processing with additional sample input data sets may or may not be performed. For example, when no error is identified after processing a first sample input data set, a second sample input data set including different values of data, differently formatted data, or the like may be processed to further stress-test the spreadsheet.

As shown in step 312, the method 300 may include updating the input data criteria. The input data criteria may be updated in response to identifying an error, as described in step 310. The update to the input data criteria may, or may attempt to, correct the error by including a change to at least one of the permissible data types, the permissible data values, and the permissible data positions.

Steps 306-312 of the method 300 represent a process by which the input data criteria may be tested. These steps may be repeated until there are no failures in the processing of one or more additional sample input data sets conforming to the updated input data criteria. In other words, these steps may form part of an iterative process for testing and improving the error handling capabilities of a spreadsheet.

As shown in step 314, the method 300 may include creating an allowed input directive. One or more allowed input directives may be created and associated with the source spreadsheet to specify the updated input data criteria. The allowed input directive may be automatically generated by a computing resource of a system, such as the system 100 described above.

The method 300 described above may be performed in whole or in part by a computer program product, e.g., in conjunction with a remote computing resource. Thus, an aspect described herein includes a computer program product for creating allowed input directives for spreadsheets, the computer program product comprising computer executable code embodied in a non-transitory computer readable medium that, when executing on one or more computing devices, performs the steps of: receiving a source spreadsheet including first input data processed according to one or more directives of the source spreadsheet to create first output data; analyzing the first input data and the one or more directives to identify input data criteria including at least one of (i) permissible data types, (ii) permissible data values, and (iii) permissible data positions; and testing the input data criteria. Testing the input data criteria may include: (a) generating one or more sample input data sets each including data in a spreadsheet-compatible format conforming to the input data criteria; (b) processing the one or more sample input data sets according to the one or more directives of the source spreadsheet; (c) identifying an error that causes a failure in the processing of the one or more sample input data sets, the error related to at least one of the permissible data types, the permissible data values, and the permissible data positions conforming to the input data criteria; and (d) updating the input data criteria to correct the error by changing at least one of the permissible data types, the permissible data values, and the permissible data positions. The computer program product may further include code that when executed performs the steps of: repeating aforementioned steps (a)-(d) until there are no failures in the processing of one or more additional sample input data sets conforming to the updated input data criteria, and creating an allowed input directive for the source spreadsheet that specifies the updated input data criteria. The method 300 described above may also or instead be performed by a system, such as the system 100 of FIG. 1.

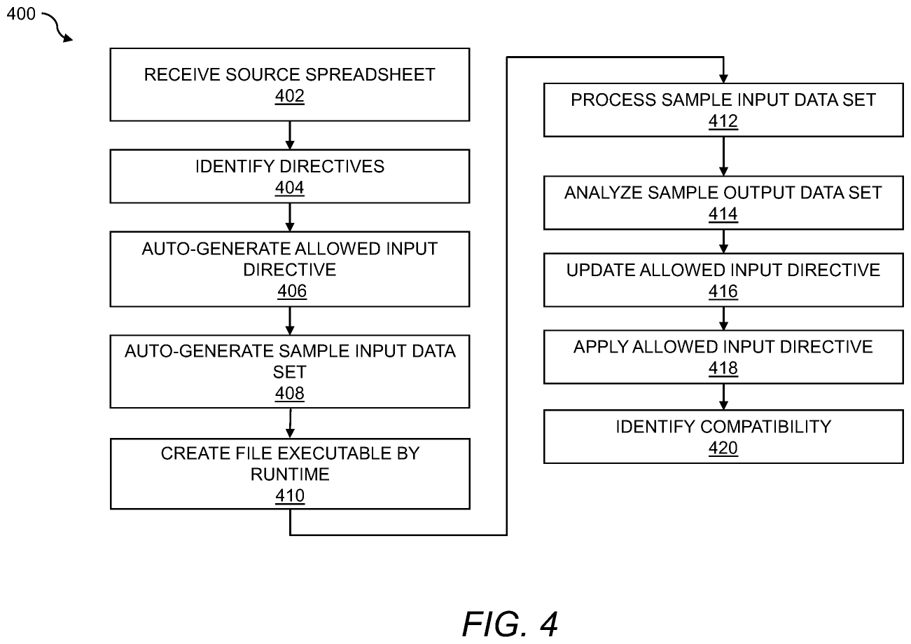

FIG. 4 is a flow chart of a method for creating allowed input directives for spreadsheets, in accordance with a representative embodiment. In general, the method 400 represents a technique for automatically generating an allowed input directive that defines input data criteria, and validating the allowed input directive using automatically generated sample input data.

As shown in step 402, the method 400 may include receiving a source spreadsheet, such as the source spreadsheet 140 of the system 100 of FIG. 1. Step 402 may be similar to steps 202 or 302 of the methods 200 or 300, and may thus include any of the features described with reference thereto. The source spreadsheet may include a first input data set (e.g., the first input data set 141) and a first output data set (e.g., the first output data set 142). The first input data set may be processed according to one or more formulas (e.g., the formula(s) 144) of the source spreadsheet to generate the first output data set.

As shown in step 404, the method 400 may include identifying one or more directives defining functionality of the source spreadsheet (e.g., one or more directives 146 defining functionality of the source spreadsheet 140 of FIG. 1). This step may be similar to step 204 of the method 200 above, and may thus include any of the features described with reference thereto. The identified directive(s) may include one or more actions taken to generate the first output data set from the first input data set (e.g., the action 149 of the system 100 of FIG. 1), wherein at least one of the one or more actions includes application of one or more formulas.

As shown in step 406, the method 400 may include automatically generating an allowed input directive. This step may be similar to step 218 of the method 200, and may thus include any of the features described with reference thereto. The allowed input directive may be automatically generated by a computing resource, such as the remote computing resource 120 of the system 100 described above. The allowed input directive may define an aspect of input data criteria including one or more of (i) permissible data types, (ii) permissible data values, (iii) permissible data positions, and the like. Such input data criteria may be derived from data included within at least one of the first input data set and the first output data set of the source spreadsheet. The allowed input directive may also or instead include one or more input directives associated with the source spreadsheet, e.g., one or more input directives describing at least one of a permissible data type, a permissible data value, and a permissible data position of the first input data set. The allowed input directive may be associated with one or more cells of the source spreadsheet, for example to indicate input data criteria related to specific cells or groups of cells. In some cases, the allowed input directive may be disposed within one or more of a note and a comment included within the source spreadsheet, or may be otherwise associated with the source spreadsheet as discussed herein.

As shown in step 408, the method 400 may include automatically generating a sample input data set. The sample input data set may be automatically generated by a computing resource, such as the remote computing resource 120 of the system 100 described above. The sample input data set may be automatically generated using the allowed input directive, such as by including data conforming to input data criteria of the allowed input directive. The sample input data set may be generated in, or converted to, a spreadsheet-compatible format such as discussed herein.

As shown in step 410, the method 400 may include creating a file executable by a runtime. This step may be similar to step 210 of the method 200, and may thus include any of the features described with reference thereto. When executed, the file may be configured to process data according to one or more directives, such as the allowed input directive. For example, processing a first input data set may include analyzing the first input data set for compliance with the input data criteria according to the allowed input directive. In a case where the input data set is determined to be non-compliant with the allowed input directive, execution of the file may stop.

As shown in step 412, the method 400 may include processing a sample input data set. Processing may be performed by a computing resource of a system, e.g., the remote computing resource 120 of the system 100 described above. The sample input data set(s) may be processed according to the one or more directives (including any allowed input directives) and the one or more formulas of the source spreadsheet to generate one or more sample output data sets. Processing the sample input data set may also include reading and executing a file using a runtime as applied to the sample input data set, in a manner similar to that discussed with regard to step 410.

As shown in step 414, the method 400 may include analyzing the sample output data set to identify an error. This step may be similar to step 310 of the method 300, and may thus include any of the features described with reference thereto.

As shown in step 416, the method 400 may include updating the allowed input directive, e.g., in response to identifying an error. Updating the allowed input directive may be based on a relationship between the error (e.g., the error identified in step 414) and the sample input data set, and may attempt to prevent future occurrences of the same or related errors. The update to the allowed input directive may include changes to one or more input data criteria (e.g., the permissible data types, the permissible data values, and the permissible data positions).

As shown in step 418, the method 400 may include applying the allowed input directive (e.g., to a data set). This step may include receiving a second input data set different from the first input data set. The allowed input directive may be applied to the second input data set to determine whether the second input data set is in compliance with the input data criteria as specified at least in part by the allowed input directive. This step may be part of a process to determine compatibility of an input data set for processing by the functionality of a spreadsheet. In some cases, a runtime may extract the allowed input directive from a file to analyze input data different from the first input data set according to the input data criteria, as described at least in part in step 410.

As shown in step 420, the method 400 may include identifying compatibility, such as compatibility of a data set for input into and processing by the source spreadsheet. For example, when some or all of the data within the second input data set is found to deviate from the input data criteria (e.g., which is at least in part specified by an allowed input directive), the second input data set may be identified as incompatible for use with the source spreadsheet. Conversely, when data within the second input data set is found to conform to the input data criteria, the second input data set may be identified as compatible for use with the source spreadsheet. Identification of incompatibility may initiate various actions, such as providing an error message, sending a notification, terminating processing, or similar. An identification of compatibility may initiate similar actions and/or may allow the data to proceed to processing (e.g., in accordance with the spreadsheet functionality).

The method 400 described above may be performed in whole or in part by a computer program product, e.g., in conjunction with a remote computing resource. Thus, an aspect described herein includes a computer program product for validating an allowed input directive for spreadsheets, the computer program product comprising computer executable code embodied in a non-transitory computer readable medium that, when executing on one or more computing devices, performs the steps of: receiving a source spreadsheet including a first input data set and a first output data set, where the first input data set is processed according to one or more formulas of the source spreadsheet to generate the first output data set; identifying one or more directives defining functionality of the source spreadsheet including one or more actions taken to generate the first output data set from the first input data set, where at least one of the one or more actions includes application of the one or more formulas; automatically generating an allowed input directive defining input data criteria including one or more of (i) permissible data types, (ii) permissible data values, (iii) permissible data positions derived from data included within at least one of the first input data set and the first output data set of the source spreadsheet, and (iv) one or more input directives describing at least one of a permissible data type, a permissible data value, and a permissible data position of the first input data set; using the allowed input directive, automatically generating a sample input data set including data in a spreadsheet-compatible format conforming to input data criteria; processing the sample input data set according to the one or more directives and the one or more formulas of the source spreadsheet to generate a sample output data set; analyzing the sample output data set to identify an error; and, in response to identifying an error updating the allowed input directive based on a relationship between the error and the sample input data set. The method 400 described above may also or instead be performed by a system, such as the system 100 of FIG. 1.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionalities may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A computer program product for determining input data criteria for spreadsheets, the computer program product comprising computer executable code embodied in a non-transitory computer readable medium that, when executing on one or more computing devices, performs the steps of:
receiving a source spreadsheet including:
a first input data set; and
a first output data set, wherein the first input data set is processed according to one or more formulas of the source spreadsheet to generate the first output data set;
identifying one or more directives defining functionality of the source spreadsheet including one or more actions taken to generate the first output data set from the first input data set, wherein at least one of the one or more actions includes application of the one or more formulas;
analyzing at least one of the first input data set, the first output data set, and the one or more directives to determine input data criteria including one or more of (i) permissible data types, (ii) permissible data values, (iii) permissible data positions derived from data positions included within at least one of the first input data set and the first output data set of the source spreadsheet, and (iv) one or more input directives describing at least one of a permissible data type, a permissible data value, and a permissible data position of the first input data set;
automatically generating a sample input data set in a spreadsheet-compatible format conforming to the input data criteria;
processing the sample input data set according to the one or more directives and the one or more formulas of the source spreadsheet to generate a sample output data set;
analyzing the sample output data set to identify an error; and
in response to identifying an error, updating the input data criteria based on a relationship between the error and the sample input data set.

2. The computer program product of claim 1, further comprising code that, when executing on one or more computing devices, performs the step of receiving an allowed input directive defining at least one of a permissible data type, a permissible data value, and a permissible data position; and including the allowed input directive in the input data criteria.

3. The computer program product of claim 2, wherein the allowed input directive is based on a relationship between the error and the sample input data set.

4. The computer program product of claim 2, further comprising code that, when executing on one or more computing devices, performs the steps of:
using the input data criteria including the allowed input directive, automatically generating a second sample input data set including data in a spreadsheet-compatible format;
processing the second sample input data set according to the one or more directives and the one or more formulas of the source spreadsheet to generate a second sample output data set; and
analyzing the second sample output data set to identify an error.

5. The computer program product of claim 1, further comprising code that, when executing on one or more computing devices, performs the steps of:
automatically generating an allowed input directive defining at least one of a permissible data type, a permissible data value, and a permissible data position; and
including the allowed input directive in the input data criteria.

6. The computer program product of claim 5, wherein the allowed input directive describes one or more of the permissible data types and the permissible data values for a collection of cells of the source spreadsheet.

7. The computer program product of claim 5, wherein the allowed input directive defines a requirement that a first collection of cells and a second collection of cells have at least one of: an identical value and an identical size.

8. The computer program product of claim 5, wherein the allowed input directive describes a relationship between a set of values of the source spreadsheet and one or more collections of cells.

9. The computer program product of claim 5, wherein the allowed input directive defines that values within a first collection of cells be unique within a worksheet of the source spreadsheet.

10. The computer program product of claim 1, further comprising code that, when executing on one or more computing devices, performs the step of creating a file executable by a runtime that is configured to process data according to the one or more directives and the one or more formulas of the source spreadsheet.

11. The computer program product of claim 10, wherein processing the sample input data set includes reading and executing the file using the runtime as applied to the sample input data set.

12. The computer program product of claim 10, wherein the file executable by the runtime is configured to analyze the first input data set for compliance with the input data criteria.

13. The computer program product of claim 10, further comprising code that, when executing on one or more computing devices, performs the steps of:
automatically generating an allowed input directive defining at least one of a permissible data type, a permissible data value, and a permissible data position; and
including the allowed input directive in the file.

14. A computer program product for creating allowed input directives for spreadsheets, the computer program product comprising computer executable code embodied in a non-transitory computer readable medium that, when executing on one or more computing devices, performs the steps of:
receiving a source spreadsheet including first input data processed according to one or more directives of the source spreadsheet to create first output data;
analyzing the first input data and the one or more directives to identify input data criteria including at least one of (i) permissible data types, (ii) permissible data values, and (iii) permissible data positions;
testing the input data criteria by:
(a) generating one or more sample input data sets each including data in a spreadsheet-compatible format conforming to the input data criteria;
(b) processing the one or more sample input data sets according to the one or more directives of the source spreadsheet;
(c) identifying an error that causes a failure in the processing of the one or more sample input data sets, the error related to at least one of the permissible data types, the permissible data values, and the permissible data positions conforming to the input data criteria; and
(d) updating the input data criteria to correct the error by changing at least one of the permissible data types, the permissible data values, and the permissible data positions;
repeating steps (a)-(d) until there are no failures in the processing of one or more additional sample input data sets conforming to the updated input data criteria; and
creating an allowed input directive for the source spreadsheet that specifies the updated input data criteria.

15. A computer program product for validating an allowed input directive for spreadsheets, the computer program product comprising computer executable code embodied in a non-transitory computer readable medium that, when executing on one or more computing devices, performs the steps of:
receiving a source spreadsheet including:
a first input data set; and
a first output data set, wherein the first input data set is processed according to one or more formulas of the source spreadsheet to generate the first output data set;
identifying one or more directives defining functionality of the source spreadsheet including one or more actions taken to generate the first output data set from the first input data set, wherein at least one of the one or more actions includes application of the one or more formulas;
automatically generating an allowed input directive defining input data criteria including one or more of (i) permissible data types, (ii) permissible data values, (iii) permissible data positions derived from data included within at least one of the first input data set and the first output data set of the source spreadsheet, and (iv) one or more input directives describing at least one of a permissible data type, a permissible data value, and a permissible data position of the first input data set;
using the allowed input directive, automatically generating a sample input data set including data in a spreadsheet-compatible format conforming to input data criteria;
processing the sample input data set according to the one or more directives and the one or more formulas of the source spreadsheet to generate a sample output data set;
analyzing the sample output data set to identify an error; and
in response to identifying an error updating the allowed input directive based on a relationship between the error and the sample input data set.

16. The computer program product of claim 15, further comprising code that, when executing on one or more computing devices, performs the step of creating a file executable by a runtime that is configured to process data according to the one or more directives.

17. The computer program product of claim 16, wherein processing the sample input data set includes reading and executing the file using the runtime as applied to the sample input data set.

18. The computer program product of claim 16, wherein the file executable by the runtime is configured to analyze the first input data set for compliance with the input data criteria according to the allowed input directive.

19. The computer program product of claim 18, wherein the runtime extracts the allowed input directive from the file to analyze input data different from the first input data set according to the input data criteria.

20. The computer program product of claim 15, further comprising code that, when executing on one or more computing devices, performs the steps of:
receiving a second input data set different from the first input data set;
applying the allowed input directive to the second input data set to determine compliance with the input data criteria;
when data within the second input data set is found to deviate from the input data criteria, identifying the second input data set as incompatible for use with the source spreadsheet; and
when data within the second input data set is found to conform to the input data criteria, identifying the second input data set as compatible for use with the source spreadsheet.
